(19) United States
(12) Patent Application Publication
(10) Pub. No.: US 2025/0133081 A1
(43) Pub. Date: Apr. 24, 2025

(54) METHODS, APPARATUSES, SYSTEMS, AND NON-TRANSITORY COMPUTER READABLE MEDIUMS FOR DETECTING FRAUD DURING USER AUTHENTICATION PROCESSES

(71) Applicant: Charles Schwab & Co., Inc., San Francisco, CA (US)

(72) Inventors: Rajneesh KUMAR, Canton, MI (US); Pete IKUSZ, Pewaukee, WI (US); William WALKER, Denver, CO (US); Bashar ABOUSEIDO, Phoenix, AZ (US)

(73) Assignee: Charles Schwab & Co., Inc., San Francisco, CA (US)

(21) Appl. No.: 18/822,743

(22) Filed: Sep. 3, 2024

Related U.S. Application Data
(60) Provisional application No. 63/545,302, filed on Oct. 23, 2023.

(51) Int. Cl. H04L 9/40

(52) U.S. Cl. CPC H04L 63/0876

(57) ABSTRACT

A server for detecting fraudulent user authentication requests is caused to receive, by a plurality of machine learning (ML) models, a dataset including user data specific to a user logging into an account during an authentication request and device data specific to a computing device used by the user to log into the account during the authentication request, generate, with the plurality of ML models configured to detect a plurality of different fraud types, a response based on the dataset, the response including at least one ML score representing a probability of at least one of the plurality of different fraud types occurring during the authentication request, and generate an authentication denial response for the authentication request based on the ML score and a threshold. Other example servers, systems, apparatuses, methods, and non-transitory computer readable medium for detecting fraudulent user authentication requests are also disclosed.

### CROSS-REFERENCE TO RELATED APPLICATIONS

This application claims the benefit of U.S. Provisional Application No. 63/545,302 filed Oct. 23, 2023, the entire disclosure of which is incorporated by reference.

### BACKGROUND

### Field

Various example embodiments relate to methods, apparatuses, systems, and/or non-transitory computer readable mediums for detecting fraud during user authentication processes, and more particularly, to methods, apparatuses, systems, and/or non-transitory computer readable mediums for detecting fraudulent user authentication requests through multiple machine learning models.

### Description of the Related Art

Companies often rely on a fraud detection system during a user authentication process to detect fraudulent activity. The user authentication process may relate to a customer logging into an account (e.g., an investment account, a bank account, etc.), an employee logging into a work account, etc. Conventionally, a risk-based authentication (RBA) approach is employed to detect a possible fraudulent activity during the user authentication process. With this rule-based approach, an RBA server receives a dataset including user and device data (e.g., a payload) associated with a user authentication process, and generates scores based on predetermined rules that are triggered according to the received dataset. The RBA server then aggregates the scores and generates an RBA response with the aggregated score for a decision server (e.g., an orchestrator), which in turn decides whether the authentication process includes fraudulent activity based on the RBA response.

### SUMMARY

At least one example embodiment is directed towards a server for detecting fraudulent user authentication requests.

In at least one example embodiment, the server may include a memory storing computer readable instructions, and processing circuitry configured to execute the computer readable instructions to cause the server to, receive, by a plurality of machine learning (ML) models, a dataset including user data specific to a user logging into an account during an authentication request and device data specific to a computing device used by the user to log into the account during the authentication request, generate, with the plurality of ML models configured to detect a plurality of different fraud types, a response based on the dataset, the response including at least one ML score representing a probability of at least one of the plurality of different fraud types occurring during the authentication request, and generate an authentication denial response for the authentication request based on the ML score and a threshold.

Some example embodiments provide that the server is further caused to compare the ML score to the threshold and generate the authentication denial response for the authentication request in response to the ML score being greater than the threshold.

Some example embodiments provide that the server is further caused to generate an authentication approval response for the authentication request in response to the ML score being less than the threshold.

Some example embodiments provide that the server is further caused to generate an authentication response with one or more additional authentication steps.

Some example embodiments provide that the response generated by the plurality of ML models is a first response, and the server is further caused to receive, by a risk-based authentication (RBA) system, the dataset including the user data and the device data, generate, with the RBA system, a second response based on the dataset and a set of defined rules, the second response including an RBA score representing an aggregation of scores generated by the defined rules when triggered by the dataset, and generate the authentication denial response for the authentication request based on the ML score and/or the RBA score.

Some example embodiments provide that the threshold is a first threshold, and the server is further caused to compare the RBA score to a second threshold and generate the authentication denial response for the authentication request in response to the ML score being greater than the first threshold and/or the RBA score being greater than the second threshold.

Some example embodiments provide that the at least one ML score is an aggregation of individual scores generated by the plurality of ML models, and each individual score represents a probability of a fraud type of the plurality of different fraud types occurring during the authentication request.

Some example embodiments provide that the server is further caused to populate a table with each individual score and corresponding fraud type, and generate the response to include the table.

Some example embodiments provide that the server is further caused to generate, with a plurality of rule-based fraud detection algorithms, an output based on the dataset, and train the plurality of ML models based on the output generated by the plurality of rule-based fraud detection algorithms and the response generated by the plurality of ML models.

Some example embodiments provide that the server is further caused to compare, by a fraud research system, the output generated by the plurality of rule-based fraud detection algorithms and the response generated by the plurality of ML models, and train the plurality of ML models based on the comparison of the output and the response.

Some example embodiments provide that the plurality of different fraud types includes at least one of account takeover fraud, new account fraud, and electronic payment fraud.

Some example embodiments provide that the plurality of ML models includes at least one unsupervised ML model and at least one supervised ML model.

At least one example embodiment is directed towards a method for detecting fraudulent user authentication requests.

In at least one example embodiment, the method may include receiving, by a plurality of machine learning (ML) models, a dataset including user data specific to a user logging into an account during an authentication request and device data specific to a computing device used by the user to log into the account during the authentication request, generating, with the plurality of ML models configured to detect a plurality of different fraud types, a response based on the dataset, the response including at least one ML score representing a probability of at least one of the plurality of different fraud types occurring during the authentication request, and generating an authentication denial response for the authentication request based on the ML score and a threshold.

Some example embodiments provide that the method further includes comparing the ML score to the threshold, wherein generating the authentication denial response for the authentication request includes generating the authentication denial response in response to the ML score being greater than the threshold.

Some example embodiments provide that the response generated by the plurality of ML models is a first response, and the method further includes receiving, by a risk-based authentication (RBA) system, the dataset including the user data and the device data, and generating, with the RBA system, a second response based on the dataset and a set of defined rules, the second response including an RBA score representing an aggregation of scores generated by the defined rules when triggered by the dataset, and generating the authentication denial response based on the ML score and/or the RBA score.

Some example embodiments provide that the threshold is a first threshold, and the method further includes comparing the RBA score to a second threshold, and generating the authentication denial response in response to the ML score being greater than the first threshold and/or the RBA score being greater than the second threshold.

Some example embodiments provide that the at least one ML score is an aggregation of individual scores generated by the plurality of ML models, and each individual score represents a probability of a fraud type of the plurality of different fraud types occurring during the authentication request.

Some example embodiments provide that the method further includes populating a table with each individual score and corresponding fraud type, and generating the response to include the table.

Some example embodiments provide that the method further includes generating, by a plurality of rule-based fraud detection algorithms, an output based on the dataset; and training the plurality of ML models based on the output generated by the plurality of rule-based fraud detection algorithms and the response generated by the plurality of ML models.

Some example embodiments provide that the method further includes comparing, by a fraud research system, the output generated by the plurality of rule-based fraud detection algorithms and the response generated by the plurality of ML models, and training the plurality of ML models based on the comparison of the output and the response.

Some example embodiments provide that the plurality of different fraud types includes at least one of account takeover fraud, new account fraud, and electronic payment fraud.

Some example embodiments provide that the plurality of ML models includes at least one unsupervised ML model and at least one supervised ML model.

At least one example embodiment is directed towards a non-transitory computer readable medium.

In at least one example embodiment, the non-transitory computer readable medium stores computer readable instructions, which when executed by processing circuitry of a server, causes the server to, receive, by a plurality of machine learning (ML) models, a dataset including user data specific to a user logging into an account during an authentication request and device data specific to a computing device used by the user to log into the account during the authentication request, generate, with the plurality of ML models configured to detect a plurality of different fraud types, a response based on the dataset, the response including at least one ML score representing a probability of at least one of the plurality of different fraud types occurring during the authentication request, and generate an authentication denial response for the authentication request based on the ML score and a threshold.

Some example embodiments provide that the server is further caused to compare the ML score to the threshold and generate the authentication denial response for the authentication request in response to the ML score being greater than the threshold.

Some example embodiments provide that the server is further caused to generate an authentication approval response for the authentication request in response to the ML score being less than the threshold.

Some example embodiments provide that the server is further caused to generate an authentication response with one or more additional authentication steps.

Some example embodiments provide that the response generated by the plurality of ML models is a first response, and the server is further caused to receive, by a risk-based authentication (RBA) system, the dataset including the user data and the device data, generate, with the RBA system, a second response based on the dataset and a set of defined rules, the second response including an RBA score representing an aggregation of scores generated by the defined rules when triggered by the dataset, and generate the authentication denial response for the authentication request based on the ML score and/or the RBA score.

Some example embodiments provide that the threshold is a first threshold, and the server is further caused to compare the RBA score to a second threshold and generate the authentication denial response for the authentication request in response to the ML score being greater than the first threshold and/or the RBA score being greater than the second threshold.

Some example embodiments provide that the at least one ML score is an aggregation of individual scores generated by the plurality of ML models, and each individual score represents a probability of a fraud type of the plurality of different fraud types occurring during the authentication request.

Some example embodiments provide that the server is further caused to populate a table with each individual score and corresponding fraud type and generate the response to include the table.

Some example embodiments provide that the server is further caused to generate, by a plurality of rule-based fraud detection algorithms, an output based on the dataset, and train the plurality of ML models based on the output generated by the plurality of rule-based fraud detection algorithms and the response generated by the plurality of ML models.

Some example embodiments provide that the server is further caused to compare, by a fraud research system, the output generated by the plurality of rule-based fraud detection algorithms and the response generated by the plurality of ML models, and train the plurality of ML models based on the comparison of the output and the response.

Some example embodiments provide that the plurality of different fraud types includes at least one of account takeover fraud, new account fraud, and electronic payment fraud.

Some example embodiments provide that the plurality of ML models includes at least one unsupervised ML model and at least one supervised ML model.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The accompanying drawings, which are incorporated in and constitute a part of the specification, illustrate one or more example embodiments and, together with the description, explain these example embodiments. In the drawings:

FIG. 1 illustrates a system for detecting fraudulent activities with an risk-based authentication (RBA) approach while machine learning (ML) models are being trained according to at least one example embodiment;

FIG. 2 illustrates a system for detecting fraudulent activities with an RBA approach and ML models according to at least one example embodiment;

FIG. 3 illustrates a system for detecting fraudulent activities with an RBA approach and ML models, while the ML models may be further trained according to at least one example embodiment;

FIG. 4 illustrates a system for detecting fraudulent activities with ML models, while the ML models may be further trained according to at least one example embodiment;

FIG. 5 illustrates another system for detecting fraudulent activities with an RBA approach and ML models according to at least one example embodiment;

FIG. 6 illustrates a block diagram of an example computing device for any one of the systems of FIGS. 1-5 according to at least one example embodiment;

FIG. 7 illustrates an example fraud detection and ML model training method associated with user authentication requests according to at least one example embodiment;

FIG. 8 illustrates an example fraud detection method associated with user authentication requests according to at least one example embodiment; and

FIG. 9 illustrates another example fraud detection and ML model training method associated with user authentication requests according to at least one example embodiment.

In the drawings, reference numbers may be reused to identify similar and/or identical elements.

### DETAILED DESCRIPTION

Various example embodiments will now be described more fully with reference to the accompanying drawings in which some example embodiments are shown.

Detailed example embodiments are disclosed herein. However, specific structural and functional details disclosed herein are merely representative for purposes of describing the example embodiments. The example embodiments may, however, may be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the example embodiments. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of the example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of the example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels, and various other mediums capable of storing, containing or carrying instruction(s) and/or data.

Furthermore, example embodiments may be implemented by hardware circuitry and/or software, firmware, middleware, microcode, hardware description languages, etc., in combination with hardware (e.g., software executed by hardware, etc.). When implemented in software, firmware, middleware or microcode, the program code or code segments to perform the desired tasks may be stored in a machine or computer readable medium such as a non-transitory computer storage medium, and loaded onto one or more processors to perform the desired tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used in this application, the term “circuitry” and/or “hardware circuitry” may refer to one or more or all of the following: (a) hardware-only circuit implementation (such as implementations in only analog and/or digital circuitry); (b) combinations of hardware circuits and software, such as (as applicable): (i) a combination of analog and/or digital hardware circuit(s) with software/firmware, and (ii) any portions of hardware processor(s) with software (including digital signal processor(s)), software, and memory(ies) that work together to cause an apparatus, such as a mobile phone, a smart device, and/or server, etc., to perform various functions); and (c) hardware circuit(s) and/or processor(s), such as microprocessor(s) or a portion of a microprocessor(s), that requires software (e.g., firmware) for operation, but the software may not be present when it is not needed for operation. For example, the circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Fraud detection during a user authentication process is at the heart of cybersecurity for many companies. Such detection and resulting authentication requirements also play an important role in user (e.g., customer, employee, etc.) satisfaction and the reputation of a company. Given the many categories of fraud and the evolving nature of how these frauds are committed, a conventional risk-based authentication (RBA) approach alone may not adequately detect a sufficient amount of fraudulent attempts with low enough false positive rates. Moreover, upkeep of rules associated with the RBA approach (e.g., manual tuning of existing rules, devising new rules, etc.) is difficult, particularly when the threat landscape changes.

Additionally, in various scenarios, a time delay may exist between when a bad actor tries to authenticate with the intention of committing a financial fraud and when an actual fraudulent transaction occurs. For example, in some cases, many days may pass between when an account takeover event occurs during an authentication request and when a fraudulent transaction occurs. Such actions make detecting suspicious login requests during the authentication process particularly hard but an equally useful endeavor. Reliable detection of such authentication requests provides a desirable defense against a variety of frauds that could be committed downstream, once the fraudster has managed to get successfully authenticated.

Further, because the nature of the fraud after authentication can vary, it is preferable to analyze user and device specific data (e.g., collected during and/or before the authentication process) in real-time with the goal of detecting different kinds of fraud. Since data related to different fraud categories can have different characteristics, a single solution framework that generically detects possibly fraudulent activities may not be sufficient to cover various types of fraud cases.

In many cases, striking a balance between detecting fraudulent attempts while minimizing false positives and negatives is difficult. For example, reliance on conventional rule-based approaches such as an RBA approach may result in a high number of false negatives (e.g., many of the suspicious requests go undetected). In such examples, it may be necessary for an analyst to spend valuable time fine tuning hundreds of rules and even creating new rules designed for detecting different categories of fault. Such actions are labor intensive and require subject matter expertise. Additionally, many of the rules tend to go stale over time as fraud landscape changes and may require deactivation to avoid generating too many false positives. Further, the RBA rules have a limited capacity for capturing historical patterns or trends in the data and a human must extract such patterns or trends, which can be a painstaking task and often results in oversimplification.

At least one example embodiment herein refers to methods, systems, devices, and/or non-transitory computer readable media for providing a machine learning (ML) based framework for detecting fraudulent user activities during authentication processes by leveraging multiple ML models trained for detecting different types of fraudulent activity. After sufficient initial training, the ML models can generate an ML response based on a received dataset associated with a user authentication process, and transmit the ML response a decision server (e.g., an orchestrator). In such examples, the ML models may analyze the same authentication data in the received dataset as processed by an RBA (ruled-based) server but in a different framework. As such, in various embodiments, the ML response generated by the ML models can supplement, or optionally supersede, an RBA response. In such scenarios, the decision-making orchestrator can take in inputs from the RBA server and/or the ML models, and decide how to respond to a user authentication request.

Such ML model-based architectures are able to handle a high request volume and enable near real-time decision making, while providing a higher accuracy and robustness over RBA-alone systems. Additionally, due to the training (and retraining when necessary) of the ML models on different types of fraudulent activity, the ML model-based architectures herein may be safeguarded from being outdated, thereby enabling detection across the fraud landscape which is constantly evolving with new threat vectors continuously emerging. Such capabilities minimize false positives and increase user satisfaction.

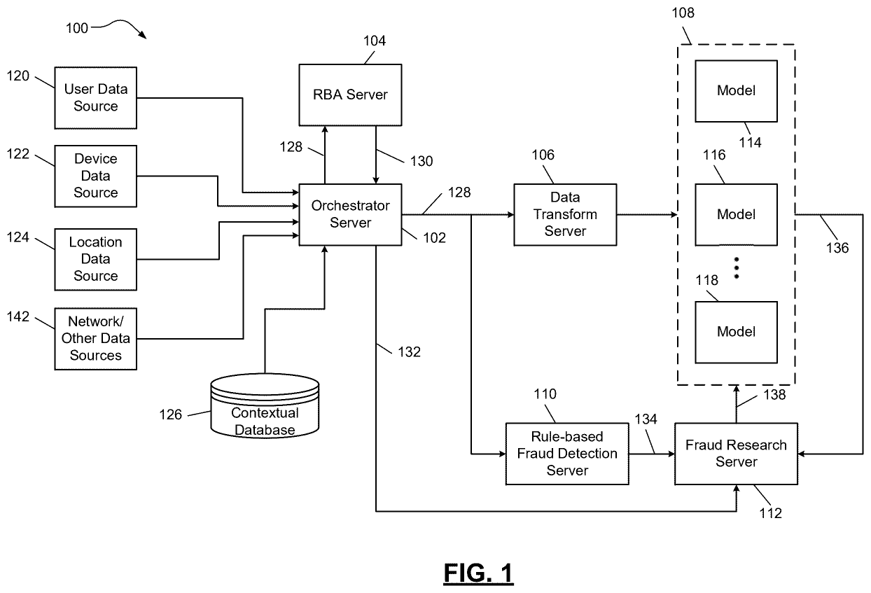

FIGS. 1-5 illustrate fraud detection systems associated with ML based frameworks according to example embodiments. The ML-based frameworks of FIGS. 1-5 may be implemented for training and/or implemented for detecting fraudulent activities associated with users and/or devices during authentication processes (e.g., authentication requests). The ML based frameworks may be implemented on site, in a cloud (e.g., a public cloud, etc.), or a hybrid of the two. While the fraud detection systems of FIGS. 1-5 are generally described below with respect to authentication in account login processes, it should be appreciated that the fraud detection systems herein may be implemented for other fraud detection applications if desired.

In FIG. 1, a fraud detection system 100 is shown in which ML models are being trained. As shown in FIG. 1, the fraud detection system 100 generally includes an orchestrator server 102, an RBA server 104, a data transform server 106, a ML server 108, a rule-based fraud detection server 110, and a fraud research server 112. In the example of FIG. 1, the ML server 108 includes an ensemble of ML models 114, 116, 118. While the fraud detection system 100 of FIG. 1 is shown as including three ML models 114, 116, 118, it should be appreciated that the system 100 may include more or less ML models if desired. For example, the multiple ML models of FIG. 1 may represent a “slow” and “fast” model combination for a fraud type or one ML model for each fraud type. In such examples, “slow” and “fast” may indicate different ML models trained on longer and shorter horizon training data. Additionally, while each server in FIG. 1 is shown as a dedicated implementation, in various embodiments some or all of the orchestrator server 102, the RBA server 104, the data transform server 106, the ML server 108, the rule-based fraud detection server 110, and/or the fraud research server 112 may be implemented as a single server or multiple servers if desired.

According to some example embodiments, the orchestrator server 102 receives one or more datasets relating to user and device specific data from various optional data sources 120, 122, 124, 142. The datasets may be provided in a batch (e.g., offline) mode or a streaming (e.g., online) mode where the collected data is transmitted and fed continuously in real-time. The data sources 120, 122, 124, 142 shown in FIG. 1 are only representative, and not exhaustive in nature, of what information may be collected during the authentication process. As such, in some embodiments, more or less data sources may be employed to provide other exemplary user and device specific data than the data described below.

In the example of FIG. 1, the data sources 120, 122, 124 represents a user data source, a device data source, and a location data source, respectively, and the data source 142 generally represents a network and other data source for indicating whether the network is a mobile or web/browser network. In such examples, the data source 120 generally provides user data specific to a user logging into an account during an authentication process (e.g., during an authentication request). Such user specific data may include, for example, voice samples, biometric samples (e.g., facial features, etc.), authentication inputs (e.g., user provided answers to confirmatory questions, etc.), passwords, usernames, and/or other data relating to a known user for the system. Additionally, the data sources 122, 124 generally provide device data specific to a computing device used by the user to log into the account during the authentication process. For example, in FIG. 1, the data source 122 may provide device fingerprint data specific to the computing device that unique identifies (or fingerprints) the user. Such information may include device software data, device settings data, etc. collected when the user visits various websites through a browser on the computing device. The data source 124 of FIG. 1 provides an IP address associated with the computing device and/or other suitable data to identify a location of the computing device being used to log into the account.

The orchestrator server 102 may optionally enrich the received data with contextual data. For example, and as shown in FIG. 1, the orchestrator server 102 receives an input from a contextual database 126. This input may provide contextual data, such as user credentials, device risks, location risks, historical account balances, email histories, passwords, address changes, phone number changes, etc. Such information provides context to the data received from the data sources 120, 122, 124. For example, if an IP address indicates a new location of the device (e.g., not seen during a previous authentication request), the orchestrator server 102 may put such data into context if a known address of the user has recently changed (e.g., to an address corresponding to the new location).

The orchestrator server 102 then generates and provides an authentication payload 128 to the RBA server 104 and the ML server 108. In such examples, the authentication payload 128 may generally include the collected user and device specific data from the data sources 120, 122, 124 enriched with contextual data from the contextual database 126. The authentication payload 128 generally contains the information necessary to make a decision to allow, deny or step up the authentication request of the user.

The RBA server 104 generally functions according to a conventional RBA approach. For example, the RBA server 104 receives the authentication payload 128 including the collected user and device specific data. Once received, the RBA server 104 analyzes the data, generates scores based on a set of predetermined rules that are triggered according to the received data, and then aggregates the scores into a combined (or total) RBA score. Such aggregation may include summing the individual scores generated based on the triggered rules, summing and weighing the individual scores based on predetermined conditions, averaging the individual scores, etc. Then, the RBA server 104 may generate an RBA response 130 with the aggregated score and transmit the RBA response 130 to the orchestrator server 102, as shown in FIG. 1. Such actions of the RBA server 104 may generally take place in real-time during the authentication process.

Once the RBA response 130 is received, the orchestrator server 102 may decide whether the authentication process includes fraudulent activity based on the RBA response 130. For example, the orchestrator server 102 may compare the RBA score to one or more thresholds. For instance, an analyst may determine and provide to the orchestrator server 102 a particular threshold or a threshold range (e.g., defined by minimum and maximum values). If the RBA score is within the threshold range or greater than the particular threshold, the orchestrator server 102 may determine that the authentication request is fraudulent, and provide an output 132 (e.g., an authentication denial response) to a security operation center (SOC) and/or another suitable fraud review system, such as for example the fraud research server 112 which can analyze the output 132. In various embodiments, one or more investigators may analyze the output 132 as well. If, however, the RBA score is outside (e.g., below) the threshold range or less than the particular threshold, the orchestrator server 102 may determine that the authentication request is not fraudulent, and provide the output 132 in the form of an authentication approval response.

In some examples, the authentication denial response may also trigger an automatic denial of the authentication request thereby preventing the user from accessing his/her account. In other examples, the orchestrator server 102 and/or the SOC may generate an authentication response that requires a step-up in authentication requirements. For example, the orchestrator server 102 may generate the authentication response with one or more additional authentication steps when the RBA score is within the threshold range or greater than the particular threshold. In such examples, the orchestrator server 102 may determine that the user must provide a multi-factor login, a token, and/or another additional security requirement to complete the authentication process. The orchestrator server 102 may decide to require the additional authentication step(s) and identify which authentication step(s) are required based on the RBA score.

As shown in FIG. 1, the authentication payload 128 is also fed to a ML pipeline that processes the data and creates features for the purpose of model training and making prediction during model deployment. For example, and as shown in FIG. 1, the ML server 108 receives (and more specifically the ML models 114, 116, 118 receive) the same authentication payload 128 that is provided to the RBA server 104. In various embodiments, the authentication payload 128 provided to the ML server 108 may be sent in a batch mode or a streaming mode.

In such examples, the authentication payload 128 is received by the ML models 114, 116, 118 via the data transform server 106. In various embodiments, the data transform server 106 may perform data preprocessing to prepare the received user and device specific data (e.g., raw data) to enable feature engineering. For instance, some or all of the raw data from the data sources 120, 122, 124 may be in unusable and/or undesirable formats. In such examples, the data transform server 106 may normalize (e.g., translate or transform) the raw data having unusable and/or undesirable formats into a standardized format, and then aggregate the normalized data (and any raw data already in a useable and/or desirable format).

In the example of FIG. 1, the authentication payload 128 is received by the ML models 114, 116, 118 for use in training the ML models. For example, depending on the types of fraud for which data exists and a desired interest in detecting certain types of fraud, a number of ML models can be trained for detecting different types of fraud based on the same payload data. For instance, the ML model 114 may be trained for detecting account takeover (ATO) fraud, the ML model 116 may be trained for detecting new account (NAF) fraud, and the ML model 118 may be trained for detecting electronic payment fraud (e.g., electronic bank-to-bank payment (ACH) fraud, etc.). In other examples, any one or more of the ML models 114, 116, 118 and/or additional ML models in the ML server 108 may be trained to detect other suitable frauds, such as debit and check fraud, scams, social engineering, etc. Additionally, in some examples, multiple ML models, in “slow” and “fast” combination, for a single fraud category may be deployed.

In such examples, the ML models 114, 116, 118 may belong to any suitable classical or neural network model families depending on, for example, the characteristics of the payload data and the nature of the fraud itself. In such examples, the ML models 114, 116, 118 each may be a single model or an ensemble of many different models, may be rule-based, etc. For example, an unsupervised clustering model may be suitable for the NAF model (e.g., the ML model 116, etc.) given that new account login requests for the purpose of fraud may appear different from logins from regular customers. Additionally, a supervised gradient booted tree model in conjunction with deep neural network may be suitable for the ATO model (e.g., the ML model 114, etc.).

In FIG. 1, the ML models 114, 116, 118 are deployed in “listen only” or shadow mode. In other words, a model prediction from the ML server 108 is not sent to the orchestrator server 102 during model serving and the RBA response 130 is the only input available to orchestrator server 102 for decision making. In such examples, a model prediction is directed to the fraud research server 112. For example, the ML models 114, 116, 118 generate a model prediction based on the authentication payload 128 including the collected user and device specific data. The model prediction may be in the form of one or more scores (e.g., a score between 0 and 1, etc.). The ML server 108 generates a ML response 136 with the one or more scores for the fraud research server 112, as shown in FIG. 1.

As shown in FIG. 1, the rule-based fraud detection server 110 also receives the authentication payload 128. In such examples, the authentication payload 128 may be sent to the rule-based fraud detection server 110 in a batch mode or a streaming mode. In various embodiments, the rule-based fraud detection server 110 analyzes the authentication payload 128 including the collected user and device specific data along with other datasets and generates an output 134 based on the dataset. For example, the rule-based fraud detection server 110 includes a set of rules (e.g., rule-based fraud detection algorithms) that may be different than the predetermined rules associated with the RBA server 104. The rule-based fraud detection server 110 may apply applicable rules from the set of rules on the data in the authentication payload 128 and other collected data (e.g., data from past actions of the user, etc.), and then generate one or more scores based on the triggered rules. In such examples, the one or more scores generated by the rule-based fraud detection server 110 may be a more accurate representation of the possibility of fraud than for example, the score(s) generated by the RBA server 104 due to the reliance on other (non-real time) data. The rule-based fraud detection server 110 then transmits the output 134 with the generate score(s) to the fraud research server 112, as shown in FIG. 1.

The fraud research server 112 then analyzes the ML response 136 from the ML server 108 and the output 134 from the rule-based fraud detection server 110, which operate based on the same payload data. For example, the fraud research server 112 may compare the ML score(s) of the ML response 136 and the score(s) of the output 134. Additionally, in some examples, one or more investigators (e.g., a team of investigators) may also scrutinize the ML model response 136 and indicate whether it's correct or incorrect for each authentication sample.

The fraud research server 112 then provides feedback for training the ML models 114, 116, 118. For example, the fraud research server 112 generates an output 138 including feedback based on the comparison between the ML response 136 from the ML server 108 and the output 134 from the rule-based fraud detection server 110. In some examples, an outcome of the investigation by the investigator(s) may be provided with the output 138. As shown in FIG. 1, the output 138 is provided to the ML server 108 for training the ML models 114, 116, 118, fine tuning model hyperparameters, etc. For example, the individual ML models 114, 116, 118 and/or the collective stack of models 114, 116, 118 may be trained and tuned until they meet or exceed a performance requirement outlined in a service level agreement (SLA). Once the models 114, 116, 118 meet or exceed the performance requirement, their predictions (collectively, the ML response) can be made available to the orchestrator server 102 for decision making.

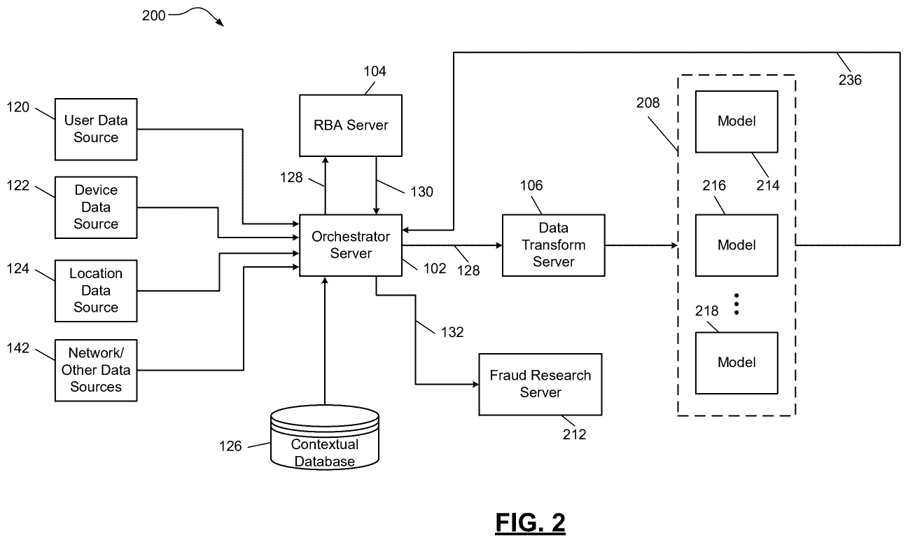

Additionally, once the ML models 114, 116, 118 are adequately trained and validated individually on the training data, they may be stacked in any suitable configuration. For example, the ML models (e.g., the trained ML models of FIGS. 2-5) may be stacked in a parallel configuration. With this arrangement, a particular authentication request may be processed to detect many different types (ATO, NAF, ACH, etc.) of fraud, all at once. In other examples, the individual ML models may be stacked in a sequential configuration so that features created from the payload data arc fed in a sequence, rather than simultaneously.

FIG. 2 depicts a fraud detection system 200 that is substantially similar to the fraud detection system 100 FIG. 1, but in which no further model training is required and the final model response can be sent directly to the orchestrator server 102. For example, and as shown in FIG. 2, the fraud detection system 200 includes the orchestrator server 102, the RBA server 104, the data transform server 106, the data sources 120, 122, 124, the contextual database 126, the authentication payload 128, the RBA response 130, and the orchestrator output 132 of FIG. 1. These components function and interact as explained above.

As shown in FIG. 2, the fraud detection system 200 further includes a ML server 208 having ML models 214, 216, 218. The ML server 208 and the ML models 214, 216, 218 of FIG. 2 are the same as the ML server 108 and the ML models 114, 116, 118 of FIG. 1, but where the ML models 214, 216, 218 are trained to detect different types of fraud as explained above. In the example of FIG. 2, the trained ML models 214, 216, 218 may be stacked in a parallel configuration or a sequential configuration as explained above.

As shown in FIG. 2, the ML server 208 (e.g., the ML models 214, 216, 218) receives the authentication payload 128 including the collected user and device specific data. In such examples, the authentication payload 128 may be sent to the ML server 208 in a batch or streaming mode as explained above. Additionally, each individual ML model 214, 216, 218 can act on the entire payload data or on a subset of the payload data that applies to that ML model and ignore the rest. The ML server 208 then generates a ML response 236 based on the dataset. For example, the ML models 214, 216, 218 may generate one or more ML scores (e.g., between 0 and 1, etc.) based on the user and device specific data collected before and during an authentication request. Such ML scores may represent a probability of at least one of the different fraud types occurring during the authentication request. The ML score(s) are then provided with the ML response 236 to the orchestrator server 102.

The orchestrator server 102 may decide whether an authentication process includes fraudulent activity based on the RBA response 130 from the RBA server 104 and/or the ML response 236 from the ML server 208. In such examples, the orchestrator server 102 may choose to ignore one of the two responses (e.g., the RBA response 130 or the ML response 236) altogether. For example, while the RBA response 130 and the ML response 236 are generated based on the same authentication payload 128 including the collected user and device specific data, the RBA response 130 and the ML response 236 may be sufficiently different because they are generated by different frameworks underpinning their design. As such, in some circumstances, the ML response 236 may be sufficient without requiring the RBA response 130.

In other examples, the orchestrator server 102 may rely on both responses if desired. For example, the orchestrator server 102 may have the flexibility to blend the two responses (e.g., the RBA response 130 and ML response 236) in a way that takes advantage of their respective strength. For example, the responses may be combined to optimize key performance indicators (KPIs) associated with the system 200. In doing so, the number of false negatives may be decreased (e.g., and in some examples minimized), an F1 score (e.g., a ML evaluation metric that measures an accuracy of the model) associated with one or more of the ML models 214, 216, 218 may be increased (e.g., and in some examples maximized), etc. In such examples, the RBA score and the ML score may be combined (e.g., weighted, averaged, summed, etc.) to form an overall score for the authentication request. In various embodiments, the orchestrator server 102 may include a ML framework (e.g., similar to the ML server 208) that can be trained to learn how to blend the two responses for the optimal behavior.

With continued reference to FIG. 2, the orchestrator server 102 may compare the RBA score, the ML score, and/or a blended score based on the RBA score and the ML score to one or more thresholds (e.g., as set by an analyst as explained above). If the RBA score, the ML score, or the blended score is above a particular threshold, the orchestrator server 102 may determine that the authentication request is fraudulent, and provide the output 132 (e.g., an authentication denial response) to a security operation center (SOC) and/or another suitable fraud review system. In the example of FIG. 2 the orchestrator server 102 provides the output 132 to a fraud research server 212 which may analyze the output 132. In various embodiments, one or more investigators may analyze the output 132 as well.

Additionally, in some embodiments, the output 132 may include an explanation as to why the authentication request was denied. For example, the investigators (e.g., analyst, etc.) and/or the orchestrator server 102 may generate an explanation as to why the authentication request was denied. In such examples, the explanation may be included in the output 132 for auditing, customer service interactions, etc.

In other examples, the orchestrator server 102 may generate an authentication approval response for the authentication request in response to the RBA score, the ML score, and/or the blended score being less than a threshold. In such examples, the orchestrator server 102 may determine that the authentication request is not fraudulent, and generate the output 132 in the form of an authentication approval response.

In some examples, the orchestrator server 102 may generate an authentication response that requires a step-up in authentication requirements. In such examples, the orchestrator server 102 may generate the authentication response with one or more additional authentication steps, as explained above. In some examples, this authentication response may be generated in response to the RBA score, the ML score, and/or the blended score being within a defined threshold range (e.g., between the thresholds referenced above). For example, in some cases, the system 200 may receive many login requests associated with one or multiple user accounts. In such examples, the ML models 214, 216, 218 may not have high enough confidence in their predictions of a fraud for the orchestrator server 102 to deny the login requests right away. In such borderline cases, the logins can be marked so that they are subject to greater scrutiny (e.g., a step-up in authentication requirements) when requesting a financial transaction (e.g., a wire transfer downstream of the initial authentication, etc.).

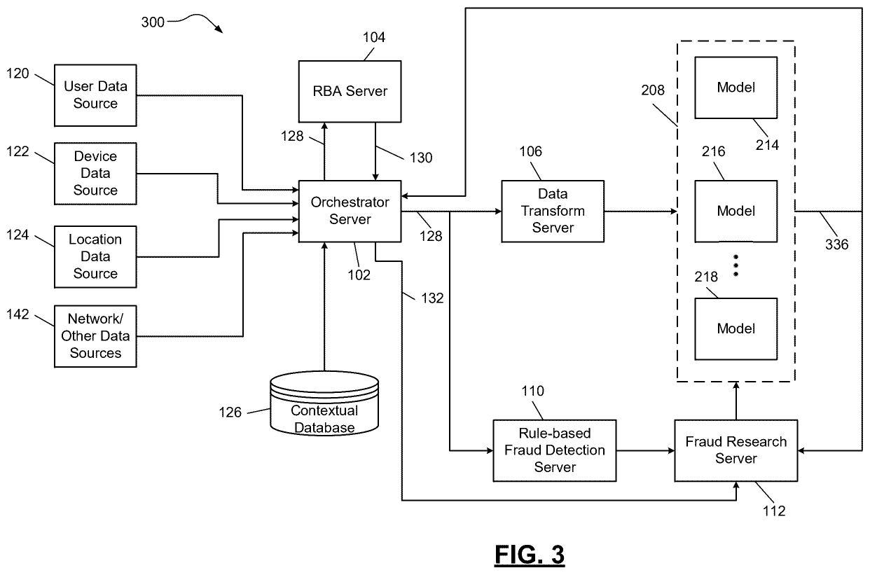

FIG. 3 depicts a fraud detection system 300 that is substantially similar to the fraud detection systems 100, 200 of FIGS. 1-2, but in which a tuning loop for the ML models is provided for training purposes while model predictions are sent to the orchestrator server 102. For example, in FIG. 3, the fraud detection system 300 includes the orchestrator server 102, the RBA server 104, the data transform server 106, the rule-based fraud detection server 110, the fraud research server 112, the data sources 120, 122, 124, the contextual database 126, the authentication payload 128, the RBA response 130, the orchestrator output 132, the ML server 208, and the ML models 214, 216, 218 of FIGS. 1-2. These components function and interact as explained above.

In the example of FIG. 3, the fraud detection system 300 may utilize a ML response generated by the ML server 208 for fraud decision making and for training purposes. For example, and as shown in FIG. 3, the ML server 208 provides a ML response 336 to the orchestrator server 102 for fraud decision making and to the fraud research server 112 for training purposes, as explained above. The ML server 208 may generate the ML response 336 in a similar manner as explained above relative to the ML response 236 of FIG. 2.

In some examples, the training functionality of the fraud detection system 300 may be turned on and off as desired. For example, the transmission of the ML response 336 to the fraud research server 112 may be selectively turned on or off per a model performance monitoring strategy. In such examples, each ML model's performance may be selectively monitored and hyperparameters associated with each ML model may be selectively tuned. In other examples, one or more of the ML models 214, 216, 218 may be entirely retrained if desired. Such configurations allow the monitoring of an individual model performance since degradation in any one of the models 214, 216, 218 may potentially throw the ML response 336 to the orchestrator server 102 off.

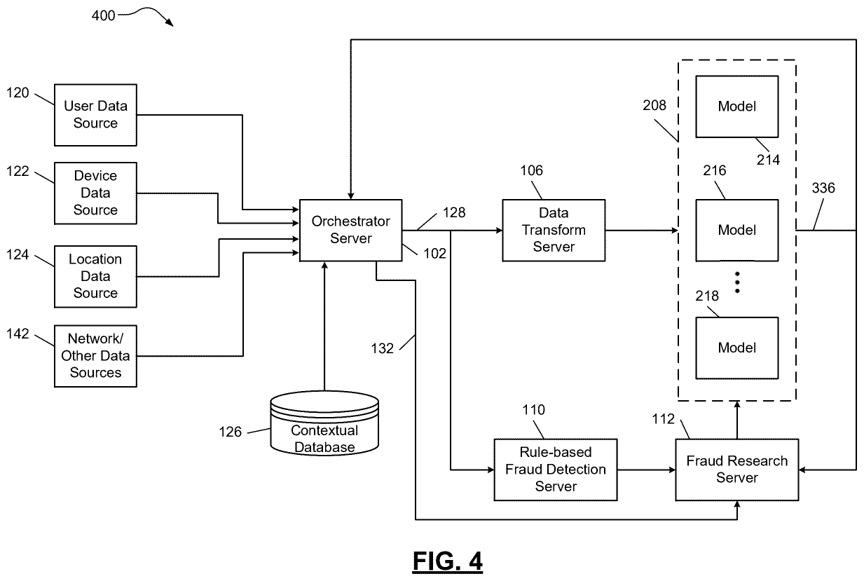

In various embodiments, the fraud detection systems herein may rely only on a ML response when ML models are trained sufficiently to ensure the ML response is accurate for fraud detection. In such examples, the a RBA server of the systems may be removed, turned off, etc. For example, FIG. 4 depicts a fraud detection system 400 that is substantially similar to the fraud detection system 300 of FIG. 3, but where the RBA server 104 is omitted. In such examples, the fraud detection system 400 includes the orchestrator server 102, the data transform server 106, the rule-based fraud detection server 110, the fraud research server 112, the data sources 120, 122, 124, the contextual database 126, the authentication payload 128, the orchestrator output 132, the ML server 208, and the ML models 214, 216, 218 of FIG. 3. These components function and interact as explained above. In the example of FIG. 4, the orchestrator server 102 makes fraud decisions based on the ML response 336 (but not an RBA response) as explained herein.

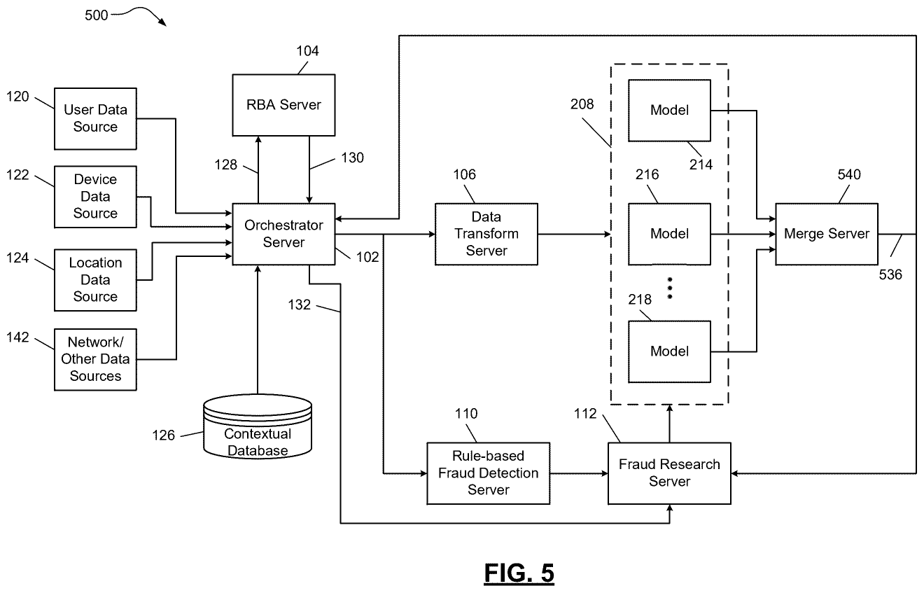

In various embodiments, the fraud detection systems herein may include a merge server for merging scores generated by ML models into a response. For example, FIG. 5 depicts a fraud detection system 500 that is substantially similar to the fraud detection system 300 of FIG. 3, but with a merger server 540. Specifically, the fraud detection system 500 includes the orchestrator server 102, the RBA server 104, the data transform server 106, the rule-based fraud detection server 110, the fraud research server 112, the data sources 120, 122, 124, the contextual database 126, the authentication payload 128, the RBA response 130, the orchestrator output 132, the ML server 208, and the ML models 214, 216, 218 of FIG. 3. These components function and interact as explained above.

In the example of FIG. 5, the merger server 540 receives outputs from the various ML models 214, 216, 218 and merges the outputs to determine which type of fraud, if any, has the highest probability of occurring for each authentication request in the payload data. For example, the merger server 540 may aggregate multiple individual scores generated by the ML models 214, 216, 218 into a collective ML score. In such examples, each individual score may represent a probability of a fraud type of the different fraud types occurring during the authentication request, as explained above. Depending on the fraud type with the highest (and significant) probability, a countermeasure can be applied.

In some examples, the merger server 540 may populate a table with each individual score and corresponding fraud type. For example, the table may include multiple individual scores representing probabilities of different fraud types (e.g., ATO, NAF, ACH, etc.) as detected by the ML models 214, 216, 218. Each score may be associated (e.g., with pointers) the particular detected fraud type. Such information may be useful for an analyst when evaluating such data.

As shown in FIG. 5, the merger server 540 may generate and provide a ML response 536 to the orchestrator server 102 for fraud decision making and to the fraud research server 112 for training purposes, as explained above. In such examples, the ML response 536 may include the populated table, the aggregated ML score, etc.

In various embodiments, the ML models of the fraud detection systems herein may be selectively switched on and/or off as desired. For example, in the fraud detection system 500 of FIG. 5, any one or more of the ML models 214, 216, 218 may be deactivated based on current tendencies, the authentication payload 128, analyst interaction, etc. In such examples, the fraud type detection capability (e.g., ATO, NAF, ACH, etc.) associated with each deactivated ML model 214, 216, 218 is dropped from the ML analysis and the ML response 536. The ML model(s) 214, 216, 218 may be switched on (e.g., activated) at a later if desired.

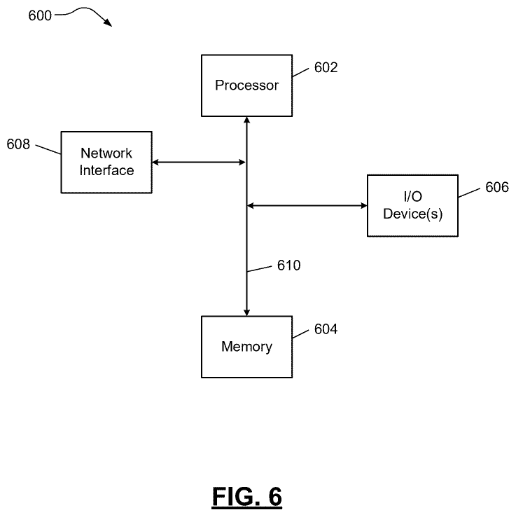

FIG. 6 illustrates a block diagram of an example computing device 600 of ML based frameworks herein according to at least one example embodiment. The computing device 600 of FIG. 6 may correspond to any one of the servers disclosed herein including, for example, the orchestrator servers, the RBA servers, the data transform servers, the rule-based fraud detection servers, the fraud research servers, the ML servers, the merger servers, etc., but the example embodiments are not limited thereto.

As shown in FIG. 6, the computing device 600 may include processing circuitry (e.g., at least one processor 602), at least one communication bus 610, memory 604, at least one network interface 608, and/or at least one input/output (I/O) device 606 (e.g., a keyboard, a touchscreen, a mouse, a microphone, a camera, a speaker, etc.), etc., but the example embodiments are not limited thereto. In the example of FIG. 6, the memory 604 may include various special purpose program code including computer executable instructions which may cause the computing device 600 to perform the one or more of the methods of the example embodiments, including but not limited to computer executable instructions related to the ML based framework explained herein.

In at least one example embodiment, the processing circuitry may include at least one processor (and/or processor cores, distributed processors, networked processors, etc.), such as the processor 602, which may be configured to control one or more elements of the computing device 600, and thereby cause the computing device 600 to perform various operations. The processing circuitry (e.g., the processor 602, etc.) is configured to execute processes by retrieving program code (e.g., computer readable instructions) and data from the memory 604 to process them, thereby executing special purpose control and functions of the entire computing device 600. Once the special purpose program instructions are loaded (e.g., into the processor 602, etc.), the processor 602 executes the special purpose program instructions, thereby transforming the processor 602 into a special purpose processor.

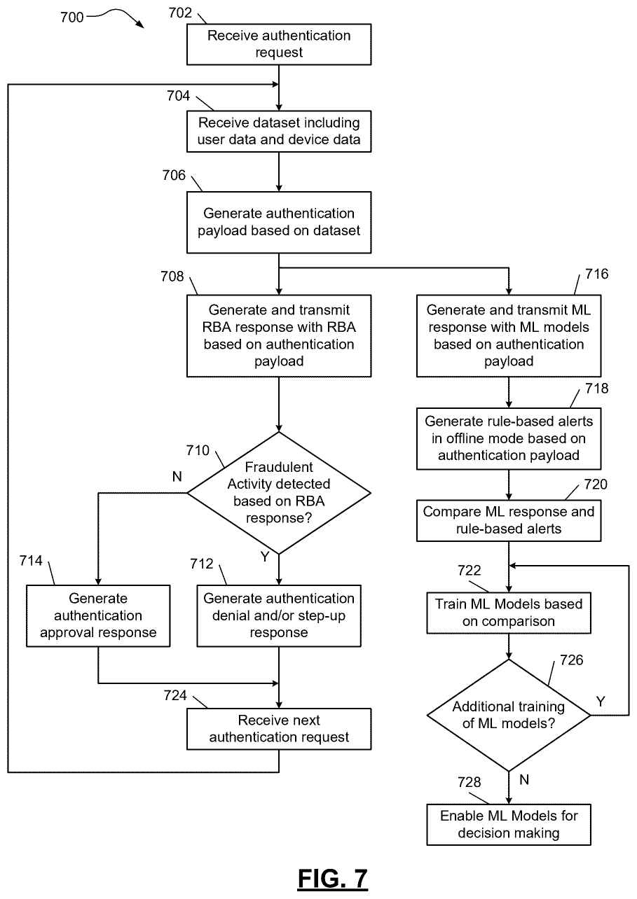

In at least one example embodiment, the memory 604 may be a non-transitory computer-readable storage medium and may include a random access memory (RAM), a read only memory (ROM), and/or a permanent mass storage device such as a disk drive, or a solid state drive. Stored in the memory 604 is program code (i.e., computer readable instructions) related to operating the ML based framework as explained herein, such as the methods discussed in connection with FIGS. 7-9, the network interface 608, and/or the I/O device 606, etc. Such software elements may be loaded from a non-transitory computer-readable storage medium independent of the memory 604, using a drive mechanism (not shown) connected to the computing device 600, or via the network interface 608, and/or the I/O device 606, etc.

In at least one example embodiment, the at least one communication bus 610 may enable communication and/or data transmission to be performed between elements of the computing device 600. The bus 610 may be implemented using a high-speed serial bus, a parallel bus, and/or any other appropriate communication technology. According to some example embodiments, the computing device 600 may include a plurality of communication buses (not shown).

While FIG. 6 depicts an example embodiment of the computing device 600, the computing device 600 is not limited thereto, and may include additional and/or alternative architectures that may be suitable for the purposes demonstrated. For example, the functionality of the computing device 600 may be divided among a plurality of physical, logical, and/or virtual servers and/or computing devices, network elements, etc., but the example embodiments are not limited thereto.

FIG. 7 illustrates an example fraud detection and ML model training method 700 associated with user authentication requests. As shown, the method 700 begins at operation 702 where an authentication request is received by a server, such as the orchestrator server 102 or another suitable server in communication with the orchestrator server 102. In such examples, the authentication request may be received in response to a user attempting to login into an account, a user requesting authentication for future logins, etc. The method 700 then proceeds to operation 704.

At operation 704, one or more datasets relating to user and device specific data are received. In some examples, the orchestrator server 102 may receive the datasets from various data sources, such as the data sources 120, 122, 124, as explained above. In various embodiments, the orchestrator server 102 may optionally enrich the received data with contextual data (e.g., received from the contextual database 126), as explained above. Then, the method 700 proceeds to operation 706.

At 706, an authentication payload is generated based on the received dataset. In some examples, the authentication payload includes the received user and device data (e.g., raw and/or enriched by the contextual data), other data associated with the authentication request, etc. as explained herein. The authentication payload is then provided to multiple fraud detection servers, such as the RBA server 104 and the ML server 108 of FIG. 1. The method 700 then proceeds to operations 708, 716.

At 708, the RBA server 104 generates an RBA response based on the authentication payload. For example, and as explained above, the RBA server 104 may generate one or more scores based on a set of predetermined rules that are triggered according to the received data (in the authentication payload), and then aggregate the scores into a combined RBA score. The RBA response, which includes the RBA score, is then transmitted to the orchestrator server 102. The method 700 then proceeds to operation 710.

At 710, the orchestrator server 102 detects whether fraudulent activity is present in the authentication request based on the RBA response. For example, and as explained above, the orchestrator server 102 may compare the RBA score from the RBA response to one or more thresholds (e.g., as set by one or more analysts), and determine whether fraudulent activity is present based on the comparison. For instance, if the RBA score is within a threshold range or greater than a particular threshold, the orchestrator server 102 may determine that the authentication request is fraudulent. If the authentication request is deemed to have fraudulent activity, the method 700 proceeds to operation 712 where the orchestrator server 102 generates an authentication denial and/or step-up response (e.g., a denial and/or a step-up in authentication requirements) as explained herein. If, however, the RBA score is outside the threshold range or less than a particular threshold, the orchestrator server 102 may determine that the authentication request is not fraudulent. In such scenarios, the method 700 proceeds to operation 714 where the orchestrator server 102 generates an authentication approval response as explained herein. The method 700 then proceeds to operation 724, where another (e.g., the next) authentication request is received. The method 700 then returns to operation 704.

At 716, the ML server 108 generates a ML response based on the authentication payload. For example, and as explained above, ML models (e.g., the ML models 114, 116, 118 of FIG. 1) of the ML server 108 may process the received user and device data from the authentication payload and other data associated with the authentication request and/or previous authentication requests, and then generate model predictions (e.g., ML scores, etc.). In such examples, the ML models are deployed in “listen only” or shadow mode for training purposes. The method 700 then proceeds to operation 718.

At 718, rule-based alerts are generated in an offline mode based on the authentication payload. For example, a rule-based fraud detection server (e.g., the rule-based fraud detection server 110 of FIG. 1) may receive the authentication payload and/or other data, such as data from previous authentication requests, RBA responses, etc. associated with the user and/or other users. The rule-based fraud detection server then applies applicable rules from a set of rules on the data and generates one or more scores based on the triggered rules. In such examples, the set of rules associated with the rule-based fraud detection server may be the same or different than the rules associated with the RBA server 104. The method 700 then proceeds to operation 720.

At 720, the rule-based alerts from the rule-based fraud detection server and the ML response from the ML server 108 are compared. For example, and as explained above, a fraud research server (e.g., the fraud research server 112 of FIG. 1) may receive and analyze the rule-based alerts and the ML response which are generated based on the same payload data. In various embodiments, the fraud research server may analyze the responses by comparing the ML scores from the ML server 108 and the scores from the rule-based fraud detection server. The method 700 then proceeds to operation 722.

At 722, the ML models of the ML server 108 are trained based on the comparison between the rule-based alerts and the ML response. In such examples, the fraud research server may provide feedback for training the ML models. In various embodiments, any one of the ML models can be trained for detecting a different type of fraud based on the same payload data, such as ATO fraud, NAF fraud, electronic payment fraud, etc. as explained above. The method 700 then proceeds to operation 726.

At 726, the comparison between the rule-based alerts and the ML response may be evaluated to determine whether additional training of the ML models 114, 116, 118 of FIG. 1 is necessarily. For example, the ML server 108 and/or the fraud research server 112 of FIG. 1 may detect whether performance of the ML models 114, 116, 118 falls above or below a threshold. If additional training is not necessary (e.g., the performance of the ML models 114, 116, 118 exceeds the threshold), the method 700 proceeds to operation 728 where the ML models are enabled and usable for decision making. If, however, additional training is necessary (e.g., the performance of the ML 114, 116, 118 falls below the threshold), the method 700 returns to operation 722 as shown in FIG. 7.

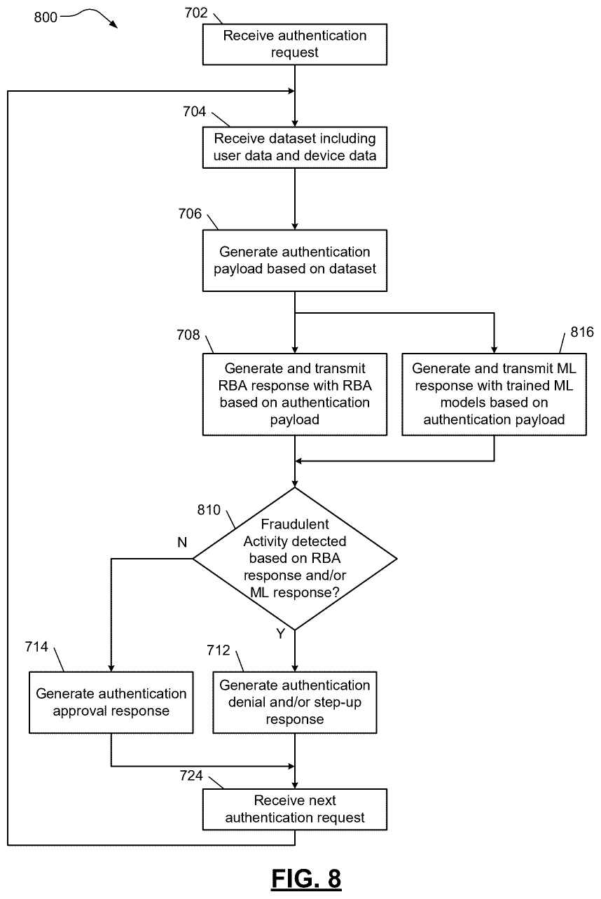

FIG. 8 illustrates an example fraud detection method 800 associated with user authentication requests. The method 800 of FIG. 8 is similar to the method 700 of FIG. 7, but with alternative operations. For example, the method 800 of FIG. 8 includes operations 702, 704, 706, 708, 712, 714, 724, which are explained above relative to the method 700 of FIG. 7. In the method 800 of FIG. 8, the authentication payload (generated at operation 706) is provided to multiple fraud detection servers, such as the RBA server 104 and the ML server 208 of FIG. 2. The method 800 then proceeds to operations 708 (explained above) and 816.

At 816, the ML server 208 generates a ML response based on the authentication payload. For example, and as explained above, trained ML models (e.g., the ML models 214, 216, 218 of FIG. 2) of the ML server 208 may process the received user and device data, other data associated with the authentication request, etc. from the authentication payload and then generate model predictions (e.g., ML scores, etc.). In such examples, the trained ML models may detect different types of fraud (e.g., ATO fraud, NAF fraud, electronic payment fraud, etc.) as explained above. The model predictions may be merged into a final ML score, which is then transmitted to the orchestrator server 102 for decision making, as explained above. The method 800 then proceeds to operations 810.

At 810, the orchestrator server 102 detects whether fraudulent activity is present in an authentication request based on the RBA response (from operation 708) and/or the ML response (from operation 816). For example, and as explained above, the orchestrator server 102 may choose to ignore one of the two responses (e.g., the RBA response or ML response) altogether or combine the responses in a way that takes advantage of their respective strengths, as explained above. In either case, the orchestrator server 102 may compare the RBA score from the RBA response, the ML score from the ML response, and/or a combined score to one or more thresholds (e.g., as set by one or more analysts), and determine whether fraudulent activity is present based on the comparison, as explained above. If the authentication request is deemed to have fraudulent activity, the method 800 proceeds to operation 712 where the orchestrator server 102 generates an authentication denial response as explained above. If, however, the authentication request is deemed to not have fraudulent activity, the method 800 proceeds to operation 714 where the orchestrator server 102 generates an authentication approval response as explained above.

Then, the method 700 proceeds to operation 724 where another (e.g., the next) authentication request is received and returns to operation 704.

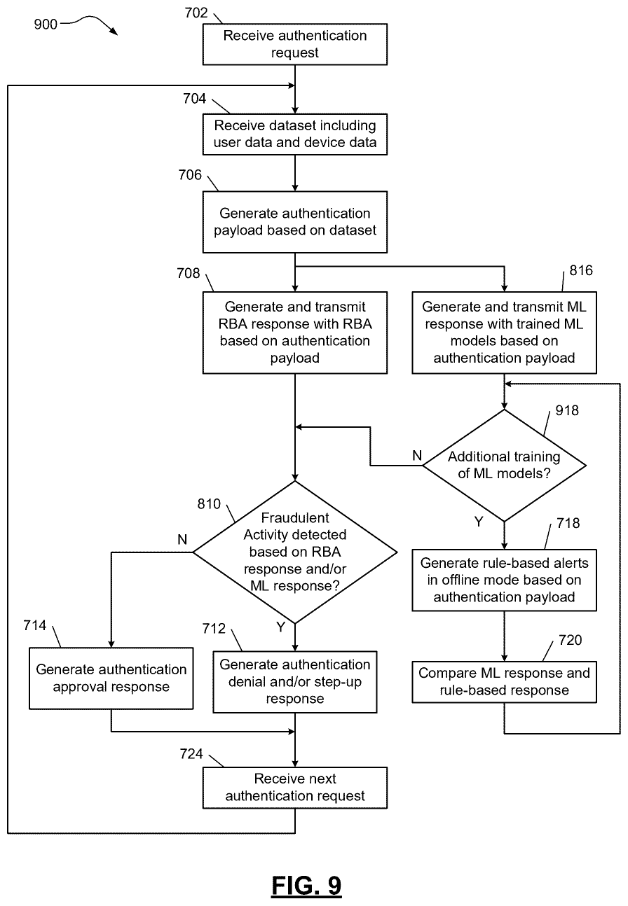

FIG. 9 illustrates another example fraud detection method 900 associated with user authentication requests. The method 900 of FIG. 9 is similar to the methods 700, 800 of FIGS. 7-8, but with alternative operations. For example, the method 900 of FIG. 9 includes operations 702, 704, 706, 708, 712, 714, 718, 720, 724, 810, 816, which are explained above relative to the methods 700, 800 of FIGS. 7-8.

In the method 900 of FIG. 9, the ML response generated at operation 816 may be evaluated at operation 918 to determine if additional training (e.g., retraining, tuning, etc.) of the trained ML models 214, 216, 218 is necessary. For example, the ML server 208 and/or a fraud research server (e.g., the fraud research server 112 of FIG. 3) may detect whether performance of the ML models 214, 216, 218 falls below a threshold. If additional training is not necessary (e.g., the performance of the ML models 214, 216, 218 exceeds the threshold), the method 900 proceeds to operation 810 as explained above relative to the method of FIG. 8. If, however, additional training is necessary (e.g., the performance of the ML models 214, 216, 218 falls below the threshold), the method 900 proceeds to operations 718, 720 where rule-based alerts are generated and a comparison is made between the rule-based alerts and the ML response. Then, the method 900 returns to operation 918 after the ML models 214, 216, 218 are further trained as explained herein.

While FIGS. 7-9 illustrate various methods related to fraud detection and/or ML model training, the example embodiments are not limited thereto. Additionally, other methods may be used and/or modifications to the methods of FIGS. 7, 8 and/or 9 may be used to perform the fraud detection and/or ML model training if desired.

Various example embodiments are directed towards improved devices, systems, methods and/or non-transitory computer readable mediums for ML based frameworks employing ML models for detecting different types of fraudulent activity during a user authentication process and transmitting a ML response to a decision server (e.g., an orchestrator). In such examples, the ML models may analyze the same authentication data that is analyzed by an RBA server but with a different framework. With such configurations, the decision server can use the ML response generated by the ML models to supplement, or optionally supersede, an RBA response generated by the RBA server. In this manner, the decision server can handle a high request volume and enable near real-time decision making, while providing a higher accuracy and robustness over RBA-alone systems. Additionally, due to the training (and retraining when necessary) of the ML models on different types of fraudulent activity, the ML based framework may be safeguarded from being outdated, thereby enabling detection across the fraud landscape which is constantly evolving with new threat vectors continuously emerging.

This written description uses examples of the subject matter disclosed to enable any person skilled in the art to practice the same, including making and using any devices, systems, and/or non-transitory computer readable media, and/or performing any incorporated methods. The patentable scope of the subject matter is defined by the claims, and may include other examples that occur to those skilled in the art. Such other examples are intended to be within the scope of the claims.

What is claimed is:

1. A server for detecting fraudulent user authentication requests, the server comprising:
a memory storing computer readable instructions; and
processing circuitry configured to execute the computer readable instructions to cause the server to,
receive, by a plurality of machine learning (ML) models, a dataset including user data specific to a user logging into an account during an authentication request and device data specific to a computing device used by the user to log into the account during the authentication request,
generate, with the plurality of ML models configured to detect a plurality of different fraud types, a response based on the dataset, the response including at least one ML score representing a probability of at least one of the plurality of different fraud types occurring during the authentication request, and
generate an authentication denial response for the authentication request based on the ML score and a threshold.

2. The server of claim 1, wherein the server is further caused to compare the ML score to the threshold and generate the authentication denial response for the authentication request in response to the ML score being greater than the threshold.

3. The server of claim 1, wherein the server is further caused to generate an authentication approval response for the authentication request in response to the ML score being less than the threshold.

4. The server of claim 1, wherein the server is further caused to generate an authentication response with one or more additional authentication steps.

5. The server of claim 1, wherein
the response generated by the plurality of ML models is a first response, and
the server is further caused to receive, by a risk-based authentication (RBA) system, the dataset including the user data and the device data, generate, with the RBA system, a second response based on the dataset and a set of defined rules, the second response including an RBA score representing an aggregation of scores generated by the defined rules when triggered by the dataset, and generate the authentication denial response for the authentication request based on the ML score and/or the RBA score.

6. The server of claim 5, wherein
the threshold is a first threshold, and
the server is further caused to compare the RBA score to a second threshold and generate the authentication denial response for the authentication request in response to the ML score being greater than the first threshold and/or the RBA score being greater than the second threshold.

7. The server of claim 1, wherein the at least one ML score is an aggregation of individual scores generated by the plurality of ML models, and each individual score represents a probability of a fraud type of the plurality of different fraud types occurring during the authentication request.

8. The server of claim 1, wherein the server is further caused to generate, with a plurality of rule-based fraud detection algorithms, an output based on the dataset, and train the plurality of ML models based on the output generated by the plurality of rule-based fraud detection algorithms and the response generated by the plurality of ML models.

9. The server of claim 8, wherein the server is further caused to compare, by a fraud research system, the output generated by the plurality of rule-based fraud detection algorithms and the response generated by the plurality of ML models, and train the plurality of ML models based on the comparison of the output and the response.

10. The server of claim 1, wherein the plurality of ML models includes at least one unsupervised ML model and at least one supervised ML model.

11. A method for detecting fraudulent user authentication requests, the method comprising:
receiving, by a plurality of machine learning (ML) models, a dataset including user data specific to a user logging into an account during an authentication request and device data specific to a computing device used by the user to log into the account during the authentication request;
generating, with the plurality of ML models configured to detect a plurality of different fraud types, a response based on the dataset, the response including at least one ML score representing a probability of at least one of the plurality of different fraud types occurring during the authentication request; and
generating an authentication denial response for the authentication request based on the ML score and a threshold.

12. The method of claim 11, further comprising comparing the ML score to the threshold, wherein generating the authentication denial response for the authentication request includes generating the authentication denial response in response to the ML score being greater than the threshold.

13. The method of claim 11, wherein
the response generated by the plurality of ML models is a first response,
the method further comprises receiving, by a risk-based authentication (RBA) system, the dataset including the user data and the device data, and generating, with the RBA system, a second response based on the dataset and a set of defined rules, the second response including an RBA score representing an aggregation of scores generated by the defined rules when triggered by the dataset, and
generating the authentication denial response for the authentication request includes generating the authentication denial response based on the ML score and/or the RBA score.

14. The method of claim 13, wherein
the threshold is a first threshold,
the method further comprises comparing the RBA score to a second threshold, and
generating the authentication denial response for the authentication request includes generating the authentication denial response in response to the ML score being greater than the first threshold and/or the RBA score being greater than the second threshold.

15. The method of claim 11, wherein the at least one ML score is an aggregation of individual scores generated by the plurality of ML models, and each individual score represents a probability of a fraud type of the plurality of different fraud types occurring during the authentication request.

16. The method of claim 15, wherein generating the response includes populating a table with each individual score and corresponding fraud type, and generating the response to include the table.

17. The method of claim 11, further comprising generating, by a plurality of rule-based fraud detection algorithms, an output based on the dataset; and training the plurality of ML models based on the output generated by the plurality of rule-based fraud detection algorithms and the response generated by the plurality of ML models.

18. The method of claim 17, wherein
the method further comprises comparing, by a fraud research system, the output generated by the plurality of rule-based fraud detection algorithms and the response generated by the plurality of ML models, and
training the plurality of ML models includes training the plurality of ML models based on the comparison of the output and the response.

19. The method of claim 11, wherein the plurality of ML models includes at least one unsupervised ML model and at least one supervised ML model.

20. A non-transitory computer readable medium storing computer readable instructions, which when executed by processing circuitry of a server, causes the server to:
receive, by a plurality of machine learning (ML) models, a dataset including user data specific to a user logging into an account during an authentication request and device data specific to a computing device used by the user to log into the account during the authentication request;
generate, with the plurality of ML models configured to detect a plurality of different fraud types, a response based on the dataset, the response including at least one ML score representing a probability of at least one of the plurality of different fraud types occurring during the authentication request; and
generate an authentication denial response for the authentication request based on the ML score and a threshold.
